(19) United States
(12) Patent Application Publication
(10) Pub. No.: US 2022/0371245 A1
(43) Pub. Date: Nov. 24, 2022

(54) INJECTION UNIT FOR A MOLDING MACHINE

(71) Applicant: ENGEL AUSTRIA GmbH, Schwertberg (AT)

(72) Inventors: Guenther KLAMMER, Aschbach Markt (AT); Erich HOCHREITER, Schwertberg (AT); Andreas HOELZL, Asten (AT); Klaus FELLNER, Steyr (AT)

(21) Appl. No.: 17/748,755

(22) Filed: May 19, 2022

(30) Foreign Application Priority Data
May 20, 2021 (AT) A 50400/2021

(51) Int. Cl. B29C 45/50; B29C 45/80; B29C 45/60; B29C 45/62; B29C 45/70

(52) U.S. Cl. CPC B29C 45/50; B29C 45/80; B29C 45/60; B29C 45/62; B29C 45/70; B29C 2945/76665; B29C 2945/76568

(57) ABSTRACT

An injection unit includes an injection cylinder and a plasticizing screw in the injection cylinder. The plasticizing screw is rotatable about a longitudinal axis for plasticizing plastic raw material and is movable linearly along the longitudinal axis for injecting molten plastic raw material. The injection cylinder has an infeed and plasticizing zone for the plastic raw material with a circular-cylindrical inner wall with a constant diameter along the longitudinal axis, a metering zone in front of the infeed and plasticizing zone along the longitudinal axis in the injection direction with a circular-cylindrical inner wall with a constant diameter along the longitudinal axis, and a nozzle head in front of the metering zone in the injection direction with a nozzle-shaped inner wall. The diameter of the circular-cylindrical inner wall of the metering zone is smaller than the diameter of the circular-cylindrical inner wall of the infeed and plasticizing zone.

The present invention (according to a first aspect) relates to an injection unit for a molding machine, in particular for an injection-molding machine, with an injection cylinder and a plasticizing screw arranged in the injection cylinder, wherein the plasticizing screw is rotatable about a longitudinal axis for plasticizing plastic raw material and is movable linearly along the longitudinal axis for injecting molten plastic raw material, wherein the injection cylinder has an infeed and plasticizing zone for the plastic raw material with a circular-cylindrical inner wall with a diameter which remains constant along the longitudinal axis, a metering zone lying in front of the infeed and plasticizing zone along the longitudinal axis in the injection direction with a circular-cylindrical inner wall with a diameter which remains constant along the longitudinal axis and a nozzle head lying in front of the metering zone in the injection direction with a nozzle-shaped inner wall. Moreover, the invention relates to a molding machine with such an injection unit.

Such injection units are used on the one hand to melt a plastic raw material and on the other hand then also to inject this plastic raw material into a cavity of a molding tool. Specially manufactured pellets are usually used as plastic raw materials. However, for environmental protection reasons it is becoming increasingly important to also melt and inject recycled plastic material via such injection units. Such recycled plastic material is usually quite large or larger than finely ground pellets, which is why the plasticizing screws and injection cylinder used need to have a certain minimum size, in order to be able to melt this recycled plastic material efficiently. Suitable plasticizing screws in a fairly small diameter range have a nominal diameter of, for example, 18 mm. With such “large” plasticizing screws, however, it is difficult to inject very small injection quantities or shot quantities of a shot weight of, for example, at most 0.5 gram, which is necessary for so-called “micro injection molding”. In the large diameter range, technological advantages result if the injection forces can be reduced. This can be achieved by a reduced plunger surface area.

The object (of the first aspect) of the present invention is therefore to create an injection unit that is improved compared with the state of the art. In particular, it is to be possible to use relatively large injection cylinders including plasticizing screws and at the same time to provide a relatively small shot weight.

This is achieved by an injection unit with the features of claim 1. Therefore, it is provided according to the invention (according to a first aspect) that the diameter of the circular-cylindrical inner wall of the metering zone is smaller than the diameter of the circular-cylindrical inner wall of the infeed and plasticizing zone.

Because the injection cylinder is smaller in the metering zone and offers less space, the space in front of the screw is also smaller and can be filled with a relatively small quantity of molten plastic raw material, which can then be injected via a stroke (e.g. with a stroke of 0.5 times to one times the nominal diameter).

In other words, the inner wall of the injection cylinder has a step which separates the infeed and plasticizing zone from the metering zone. As a result, a lot of space is available for the feeding-in and melting of relatively large recycled plastic material, while a small shot quantity accumulates in the physically smaller space in front of the screw and can be injected precisely.

The present invention (according to a second aspect) relates to an injection unit for a molding machine, in particular for an injection-molding machine, with an injection cylinder and a plasticizing screw arranged in the injection cylinder, wherein the plasticizing screw is rotatable about a longitudinal axis in a conveying direction for plasticizing plastic raw material and is movable linearly along the longitudinal axis in the injection direction for injecting molten plastic raw material. Moreover, the invention relates to a molding machine with such an injection unit.

A method for injection molding plastic molded parts is found in DE 198 34 086 C1. To plasticize plastic material a plasticizing and injection screw, which has a non-return valve at its end, is rotated in a first direction of rotation. In order to actively close the non-return valve, the plasticizing and injection screw is rotated in a direction of rotation counter to the first direction of rotation. After the backwards rotation, the injection is effected by axial displacement.

The object (of the second aspect) of the present invention is to create an injection unit that is alternative to or improved compared with the state of the art.

This is achieved by an injection unit with the features of claim 25. Therefore, it is provided according to the invention (according to a second aspect) that, during injection, at the same time as the plasticizing screw moves linearly in the injection direction the plasticizing screw is rotatable in a return direction counter to the conveying direction.

This makes it possible for the injection unit with a relatively large injection cylinder including plasticizing screw to be able to be used, but at the same time for a relatively small shot weight to be able to be provided. This injection unit is thus suitable for so-called “micro injection molding”.

In other words, it is made possible for the space in front of the screw to be narrowed by the injection cylinder. During injection, the volume which is already located in front of an infeed and plasticizing zone can be conveyed backwards again by the simultaneous backwards rotation. Thus, a jamming or an excessively high pressure can be avoided.

The present invention (according to a third aspect) relates to a cylinder front body for retrofitting on a cylinder main body of an injection cylinder, wherein the injection cylinder has a circular-cylindrical inner wall with a diameter which remains constant along the longitudinal axis.

The object (of this third aspect) of the invention is to convert or retrofit an injection unit for so-called micro injection molding in a relatively simple manner.

This is achieved by a cylinder front body with the features of claim 32. Therefore, it is provided according to the invention (according to a third aspect) that the cylinder front body has an insertion projection protruding in the direction of the cylinder main body for inserting the cylinder front body into the cylinder main body, wherein the insertion projection has a, preferably circular-cylindrical, outer surface with an outer surface diameter which corresponds at least in regions to the diameter of the circular-cylindrical inner wall of the injection cylinder, wherein the cylinder front body furthermore has a circular-cylindrical inner wall with a diameter which remains constant along the longitudinal axis and a nozzle head with a nozzle-shaped inner wall lying in front of the insertion projection and the circular-cylindrical inner wall in the injection direction, wherein the diameter of the circular-cylindrical inner wall of the cylinder front body is smaller than the outer surface diameter of the insertion projection.

Thus, it is possible, without having to replace the entire injection cylinder and its drive parts and control systems, to retrofit or convert the injection cylinder such that it is suitable for use in “micro injection molding”.

Preferred embodiment examples of the present invention(s) are given in the dependent claims.

With regard to all of the dependent claims—and also with regard to the other embodiment examples—it is to be mentioned that they apply to all aspects of the invention, provided that this makes logical sense. This means that, even if a feature is not explicitly related to one of the aspects of the invention in the text of the description or in the claims, this feature nevertheless applies to each individual aspect of the invention—provided that this likewise makes sense logically and technically.

The plasticizing screw is used not only for plasticizing—such as in the case of a pure plasticizing unit—but also for injection through the axial displacement. For this reason, the plasticizing screw can also be referred to as a plasticizing and injection screw.

With regard to the zones of a plasticizing screw, the following is to be mentioned: there are in principle three important processes which have to be carried out by a plasticizing and injection screw.

First, the plastic raw material has to be fed in. For this, the screw has a region with a relatively deep screw channel.

Then the compression of the fed-in plastic raw material is effected, as a result of which the latter is compacted, degassed, heated and melted. This is usually effected in a screw region with a screw channel that is relatively narrow or becomes narrower. This zone is usually called compression zone or plasticizing zone.

The metering and ejection of the molten plastic raw material then follow. As soon as a sufficient quantity of the plastic raw material has accumulated in front of the screw through the rotation of the screw in the conveying direction, an ejection or injection of this accumulated plastic raw material is effected through axial displacement of this screw. The screw thus functions as an injection plunger. This zone is often referred to as dosing zone or ejection zone. In this zone the screw is usually formed plunger-shaped. In order to prevent the material that has accumulated in the space in front of the screw from flowing back during injection, a non-return valve is provided in the region of the screw tip.

In the present case, the infeed zone and the compression zone are together referred to as “infeed and plasticizing zone” for the sake of simplicity. The “metering zone”, which substantially corresponds to the dosing zone or ejection zone, then follows in the injection direction.

According to a preferred embodiment example, it is provided that the diameter of the circular-cylindrical inner wall of the metering zone is at most 90%, preferably at most 70%, particularly preferably at most 50%, of the diameter of the circular-cylindrical inner wall of the infeed and plasticizing zone.

In principle, it is possible for the injection cylinder to be formed in one piece. It is also possible for the injection cylinder to consist of a plurality of individual components which are connected to each other. For an easy production, it is advantageous if the injection cylinder consists of two to four large individual parts.

It is particularly preferably provided that the injection cylinder has a cylinder main body, in which the infeed and plasticizing zone is formed.

Furthermore, it is preferably provided that the injection cylinder has a cylinder front body which is separate from the cylinder main body, arranged in front of the cylinder main body in the injection direction and detachably connected, preferably screwed, to the cylinder main body and in which the metering zone is formed.

Particularly in order to make it possible to easily produce the inner walls with different diameters, it makes sense if the cylinder main body and the cylinder front body are produced and formed as separate parts.

The cylinder front body can be formed in one piece. However, here too for an easy production, it can make sense if this cylinder front body has two main component parts produced separately.

It is preferably provided that the cylinder front body has a flange element, in which most of the metering zone is formed, and the nozzle head which lies in front of the flange element in the injection direction and is connected, preferably screwed, to the flange element.

With respect to the plasticizing screw, it is preferably provided that it has at least one screw flight and at least one screw channel. It is preferably provided that this at least one screw flight and this at least one screw channel are arranged in the region of the infeed and plasticizing zone of the injection cylinder.

In principle, it is possible for the plasticizing screw to be formed in one piece. It is also possible for the plasticizing screw to consist of a plurality of individual components which are connected to each other. For an easy production, it is advantageous if the plasticizing screw consists of two large individual parts.

According to a preferred embodiment example, it is provided that the plasticizing screw has a screw main body, wherein the screw main body is for the most part arranged in the infeed and plasticizing zone.

This screw main body preferably has the at least one screw flight and the at least one screw channel.

It is preferably provided that the maximum outside diameter of the screw main body corresponds to the diameter of the inner wall of the infeed and plasticizing zone. For perfect functioning, it is provided that there is a slight clearance, for example of from approx. 0.05% to up to 5% of the nominal diameter, between the screw main body and the inner wall of the injection cylinder.

According to a preferred embodiment example, it is provided that the plasticizing screw has a screw front body which lies in front of the screw main body in the injection direction and is preferably formed separate from the screw main body, wherein the screw front body is arranged at least partially in the metering zone.

In order to make a reliable and precise injection possible, it is preferably provided that the plasticizing screw, preferably the screw front body thereof, has a screw tip in the form of a substantially cylindrical plunger, wherein the cylindrical plunger is arranged in regions in the metering zone.

Substantially cylindrical means that this plunger need not describe a cylinder or a circular cylinder geometrically exactly. It is only important that this plunger is as well-matched as possible to the shape of the inner wall of the injection cylinder in the metering zone, with the result that the desired quantity of molten plastic raw material can be injected exactly.

The fact that the cylindrical plunger is arranged “in regions” in the metering zone of the injection cylinder means that during metering (during which the entire plasticizing screw is arranged further back relative to the injection cylinder) a smaller portion, preferably between 30% and 80%, of the cylindrical plunger is arranged in the metering zone, whereas during injection (or at the end of the injection process) a larger portion, preferably between 50% and 100%, of the cylindrical plunger is arranged in the metering zone.

Furthermore, it is preferably provided that the cylindrical plunger has a lateral surface which corresponds to the inner wall of the metering zone.

In order to guarantee a reliable guiding of the substantially cylindrical plunger in the injection cylinder, it is preferably provided that the lateral surface has a partial region formed convex (or bulging), wherein the largest diameter of the cylindrical plunger matches the diameter of the inner wall of the metering zone. Convex means that the lateral surface of the substantially cylindrical plunger in this region describes a convex curve in cross section, wherein the cross-sectional area of this cross section includes the longitudinal axis.

It is possible per se for the front face of the cylindrical plunger to be formed conical or tapered.

However, it is preferably provided that the substantially cylindrical plunger has a circular front face facing towards the nozzle head.

It is particularly preferably provided that the circular front face is formed flat.

It is quite particularly preferably provided that the flat, circular front face is aligned at right angles to the longitudinal axis. The front face thus corresponds geometrically to a base area of a right circular cylinder.

In order to guarantee an exact and reliable rotation and axial displacement of the plasticizing screw, it is preferably provided that the plasticizing screw, preferably the screw front body, has a plain bearing arranged behind the cylindrical plunger in the injection direction, wherein this plain bearing is arranged in the infeed and plasticizing zone (i.e. in the wider region of the injection cylinder). Moreover, the plain bearing lies in front of the at least one screw flight of the plasticizing screw in the injection direction.

Furthermore, it is preferably provided that the plain bearing lies against the circular-cylindrical inner wall of the infeed and plasticizing zone with a clearance, preferably with a clearance of from approximately 0.05% to 5% of the nominal diameter.

In order to convey the molten plastic raw material from the wider infeed and plasticizing zone into the narrower metering zone, it is preferably provided that the plasticizing screw, preferably the screw front body thereof, has a feed front side arranged between plain bearing and substantially cylindrical plunger and facing towards the metering zone.

In order to be able to quickly and reliably carry out the metering, it is preferably provided that the plain bearing has several melt channels, preferably formed helical in regions, for allowing molten plastic raw material to pass through from the infeed and plasticizing zone into the metering zone. Thus, it is not just the small clearance between plain bearing and inner wall of the injection cylinder that is available for the conveying.

Instead of the melt channels (in the form of depressions that are U-shaped in cross section), drilled holes can also be provided for allowing molten plastic raw material to pass through.

According to a particularly preferred embodiment example, it is provided that the injection cylinder has a transition region—preferably formed on the cylinder front body—between the circular-cylindrical inner wall of the infeed and plasticizing zone and the circular-cylindrical inner wall of the metering zone, wherein the transition region has an inner wall in the form of a lateral surface of a rotary truncated cone formed around the longitudinal axis.

Contrary to this preferred embodiment, it is (theoretically) also possible for the transition region to be formed as a flat surface, wherein the flat surface is aligned at right angles to the longitudinal axis.

This transition region thus forms a kind of annular step in the injection cylinder, through which the injection cylinder narrows from the infeed and plasticizing zone towards the metering zone.

The lateral surface of the rotary truncated cone of the transition region formed around the longitudinal axis can be formed curved or domed in a cross section including the longitudinal axis. The surface of the transition region would thus be concave spherical or concave ovoid at least in regions.

It is preferably provided that the lateral surface of the rotary truncated cone of the transition region formed around the longitudinal axis (for the most part) forms a straight line in a cross section including the longitudinal axis.

It is particularly preferably provided that the feed front side is formed—at least in regions—as a lateral surface of a right rotary truncated cone which corresponds to the transition region.

Alternatively (or additionally) it is possible for the feed front side to be designed with ridges (applied to the lateral surface). The course of these ridges can be straight, spiral or in a succession of curves. These ridges thus resemble the screw flights of a plasticizing screw.

In the foremost position, a small gap of between 0.01 mm and 3 mm can remain between the feed front side and the inner wall of the transition region. In the case of large machines this value can also be larger.

Furthermore, it can preferably be provided that a pressure sensor is provided in the transition region. This pressure sensor can be connected to a control or regulation unit, with the result that the current injection pressure can be determined.

As already mentioned in a similar manner, it is preferably provided that the plasticizing screw, preferably the screw front body thereof, has a non-return valve, preferably formed in the cylindrical plunger.

The non-return valve can be formed, for example, as a ball or check non-return valve or as a ring non-return valve. In the case of a ring non-return valve, it comprises a sealing surface, a blocking ring and a pin which holds the blocking ring in position during metering.

Preferably, it is furthermore provided that the nozzle head has a nozzle-shaped inner wall in the form of a lateral surface of a right rotary truncated cone arranged around the longitudinal axis.

It is possible for the actual outlet opening to directly form the injection-side end of the rotary truncated cone of the nozzle-shaped inner wall.

However, it is alternatively and preferably provided that the nozzle head has an opening region with a circular-cylindrical inner wall adjoining the nozzle-shaped inner wall in the injection direction. It is only the injection-side open end of this circular-cylindrical inner wall that then forms the actual outlet opening for the outlet of the plastic raw material from the injection unit.

In principle, the dimensions and sizes of the injection unit are as desired. In order to be suitable for use when recycled plastic material is being used and for use in micro injection molding, however, the following dimensions and sizes are advantageous.

According to a preferred embodiment example, it is provided that the portion of the plasticizing screw arranged in the infeed and plasticizing zone has a maximum diameter of 500 mm, preferably a diameter of between 5 mm and 450 mm.

Correspondingly, it is preferably provided that the diameter, which remains constant along the longitudinal axis, of the circular-cylindrical inner wall of the injection cylinder in the region of the infeed and plasticizing zone is at most 500 mm, preferably between 5 mm and 450 mm.

In the case of injection units that are suitable for micro injection molding, it is preferably provided that the portion of the plasticizing screw arranged in the infeed and plasticizing zone has a maximum diameter of 15 mm, preferably a diameter of between 6 mm and 12 mm.

According to a further preferred embodiment example, it is provided that the portion of the plasticizing screw arranged in the metering zone has a maximum diameter of 400 mm, preferably a diameter of between 5 mm and 350 mm.

Correspondingly, it is preferably provided that the diameter, which remains constant along the longitudinal axis, of the circular-cylindrical inner wall of the injection cylinder in the region of the metering zone is at most 400 mm, preferably between 5 mm and 350 mm.

In the case of injection units that are suitable for micro injection molding, it is preferably provided that the portion of the plasticizing screw arranged in the metering zone has a maximum diameter of 12 mm, preferably a diameter of between 5 mm and 10 mm.

Furthermore, it is preferably provided that during injection a stroke movement of the plasticizing screw relative to the injection cylinder is effected, wherein the relative stroke movement lies in a range between 0.2 times the nominal diameter of the plasticizing screw (3) and 5 times the nominal diameter of the plasticizing screw, preferably between 0.5 times and 1.2 times the nominal diameter of the plasticizing screw.

Assuming that the stroke movement is 10 mm and the diameter of the circular-cylindrical inner wall in the metering zone is 8 mm, then an injection or shot volume of 502.65 mm³ or approximately 0.5 cm³, respectively, (r²×Π×h; corresponds to 4²×Π×10) results. Such a half a cubic centimeter corresponds to a shot weight of from approximately 0.4 to 0.5 gram (depending on the discharge coefficient).

It is preferably provided that the injection unit has at least one drive device, preferably an electric motor, for moving the plasticizing screw.

The injection unit particularly preferably has a rotary drive for the rotational movement of the plasticizing screw and a separate linear drive for the axial injection movement of the plasticizing screw functioning as an injection plunger.

Furthermore, it is preferably provided that the rotational movement of the plasticizing screw is effected independently of the linear injection movement. There is therefore no positive or forced control.

According to a preferred embodiment example, the injection unit has a control or regulation unit. This control or regulation unit can be integrated in a superordinate machine control system of an entire molding machine or can be connected to it by means of signaling.

With the control or regulation unit, all movements of the injection unit can be controlled and regulated and various settings can also be made.

A control or regulation unit for controlling or regulating a rotational movement (preferably via the rotary drive mentioned) and a linear movement (preferably via the linear drive mentioned) of the plasticizing screw is preferably provided, wherein the control or regulation unit is formed, for injecting the molten plastic raw material into a cavity of a molding tool, to actuate the plasticizing screw at the same time to move linearly in the injection direction and to rotate in the return direction.

In other words, during the linear injection movement the plasticizing screw is thus actuated with a direction of rotation for conveying the material away from the cavity.

It could in principle be sufficient if the injection movement and the rotation in the return direction overlap only intermittently.

However, it is preferably provided that the movement in the return direction starts at the same time as or before the linear movement in the injection direction.

In other words, the control or regulation unit is formed to actuate the plasticizing screw such that the movement in the return direction starts at the same time as the linear movement in the injection direction.

Moreover, it is preferably provided that the movement in the return direction ends at the same time as the linear movement in the injection direction.

In other words, the control or regulation unit is formed to actuate the plasticizing screw such that the movement in the return direction ends at the same time as the linear movement in the injection direction.

Furthermore, it is preferably provided that the volume reduction due to the linear movement in the injection direction corresponds substantially (i.e. to the extent of approximately 90) to the volume returned due to the movement in the return direction. The system will therefore be kept in balance using the rotational speed during the return. This is a function of the viscosity and the rotational speed.

According to a possible embodiment example, it is provided that at least one buffer device for buffering plastic raw material during the injection is attached to the injection cylinder. This buffer device is fluidically connected to the interior of the injection cylinder.

It can be provided that this buffer device has a carrier connected to the injection cylinder, a piston movably mounted in the carrier and an energy storage mechanism (e.g. in the form of a spring, a hydraulic pressure accumulator or a pneumatic pressure accumulator) attached on the one hand to the carrier and on the other hand to the piston.

For this piston of the buffer device it is preferably provided that the piston finishes flush with the injection cylinder wall in the extended state.

The movement of the buffer device can be hydraulically, electrically or pneumatically controlled.

Protection is also sought for a molding machine with an injection unit according to the invention.

Concerning this, it is preferably provided that the molding machine has a clamping unit, wherein a molding tool is installed in the clamping unit and, in the closed state, at least one cavity is formed in the molding tool. The plastic can then be injected into this cavity via the injection unit and harden therein to form the final molded part.

With regard to the third aspect of the invention, the cylinder front body, already mentioned briefly, the following should be noted:

The implementation in mechanical engineering terms can be realized by a flange. Specifically, it can preferably be provided that the cylinder front body has connection means, preferably in the form of screws, and a flange element, wherein the cylinder front body can be detachably connected, preferably screwed, to the cylinder main body via the flange element and the connection means.

The insertion projection can be designed as a sleeve which is connected to this flange element (preferably in one piece) and extends into the injection cylinder. This sleeve (insertion projection) reduces the diameter in the space in front of the screw.

This diameter reduction in the space in front of the screw results in a longer stroke with the same injection volume, whereby the precision and repeatability are increased.

In addition, with the same injection pressure the mechanical reaction forces in the injection unit are reduced. Thus, on the one hand injection units can also be adapted subsequently for smaller shot weights and/or higher precision. On the other hand, higher injection pressures can also be realized on existing molding machines in retrofitting with the same mechanism. In addition, injection units can be designed and manufactured smaller due to the low forces.

Protection is sought, in connection with this third aspect of the invention, not only for the cylinder front body, but also for a retrofitting set comprising a cylinder front body according to the invention and a screw front body for retrofitting on a screw main body which is or can be arranged in the injection cylinder.

It is preferably provided that the screw front body has a screw tip in the form of a substantially cylindrical plunger, a plain bearing arranged behind the cylindrical plunger in the injection direction and a connection region arranged behind the plain bearing in the injection direction for detachably connecting the screw front body to the screw main body.

With regard to the retrofitting set, it is preferably provided that the cylindrical plunger has a lateral surface which corresponds to the circular-cylindrical inner wall.

Furthermore, it is preferably provided that the plain bearing has a contact surface which corresponds to the circular-cylindrical inner wall of the injection cylinder.

In order to make a retrofitting or conversion on a said retrofitting set possible or easier, it is preferably provided that an injection unit that is or can be retrofitted with the retrofitting set has a control or regulation unit, wherein the injection unit can be operated and is configured via the control or regulation unit in a retrofitting operating mode such that the control or regulation is effected depending on the dimensions of the infeed and plasticizing zone and the metering zone resulting due to the retrofitting set.

In other words, the parameters on which the control or regulation is based are also correspondingly adapted through the conversion or retrofitting.

These parameters can already be stored in the injection unit or they can be input manually with the retrofitting or conversion or read out (automatically) directly from the retrofitting set. A corresponding program, which is installed on the control or regulation unit, can also be supplied together with the retrofitting set.

Furthermore, the injection unit can be operated in a normal operating mode. Thus, the injection unit can—depending on whether the injection unit is fitted with the retrofitting set or is fitted with cylinder front bodies and screw front bodies known per se—change or be switched from the normal operating mode to the retrofitting operating mode.

Further details and advantages of the present invention are explained in more detail below with the aid of the description of the figures with reference to the embodiment examples represented in the drawings. There are shown in:

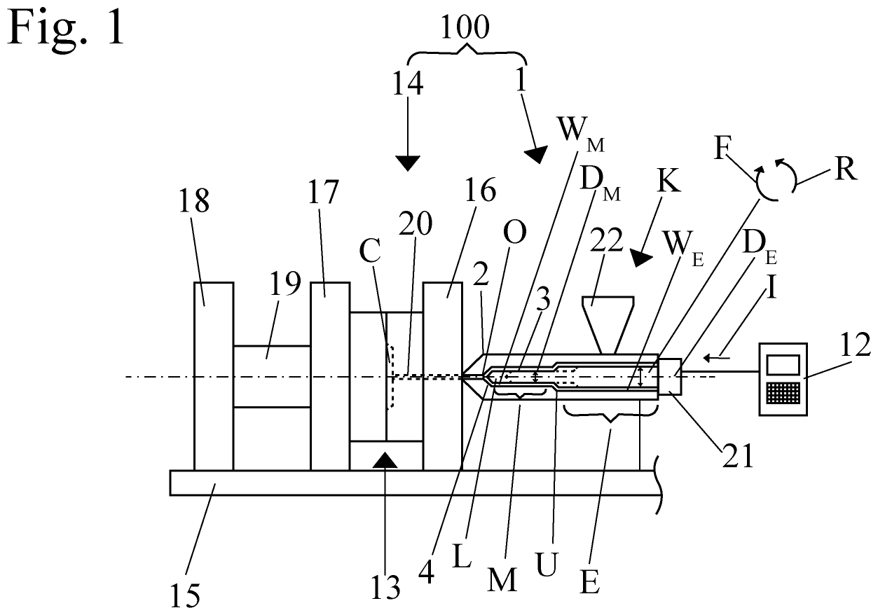

FIG. 1, schematically, a molding machine with an injection unit and a clamping unit,

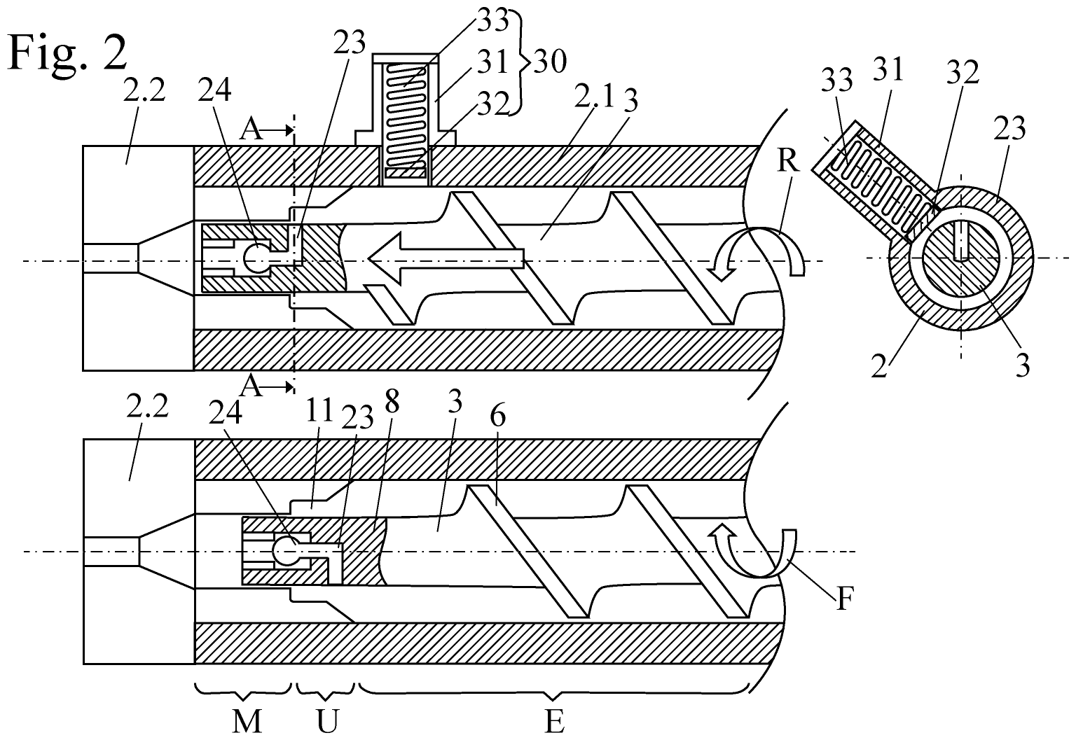

FIG. 2, schematically, the injection unit in two extreme positions and a schematic section A-A,

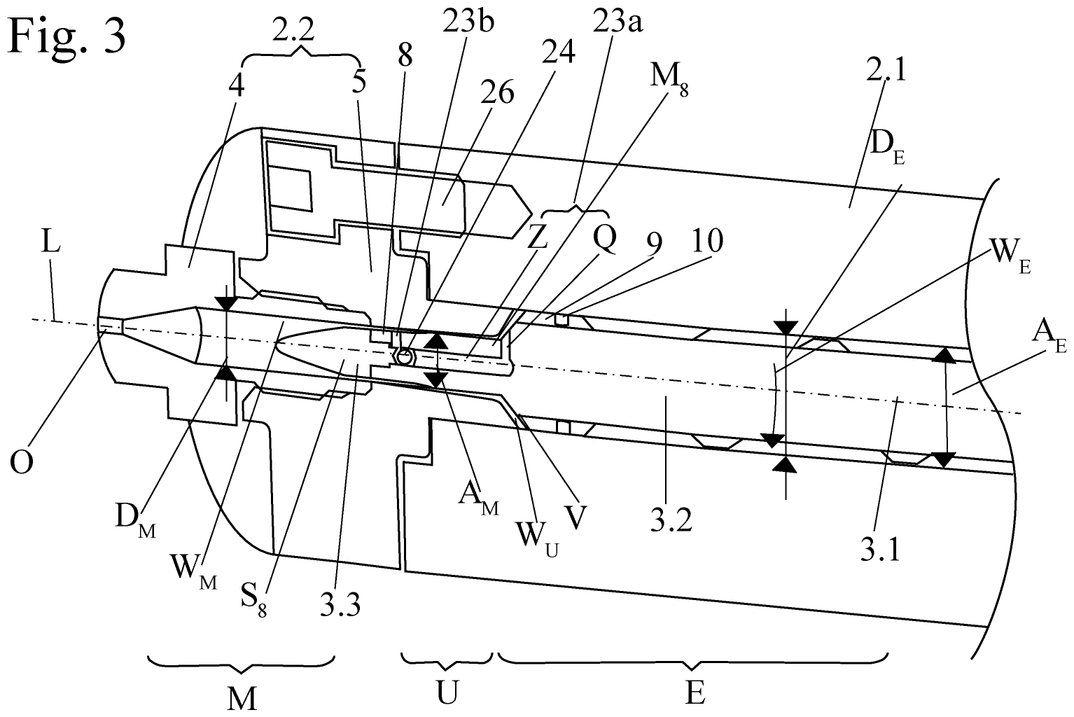

FIG. 3 a cross section through a front region of the injection unit,

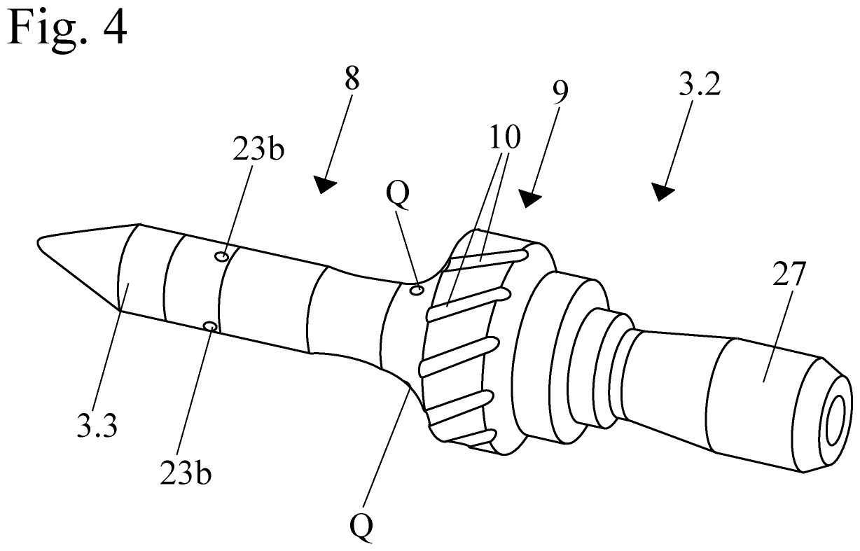

FIG. 4 a perspective representation of the screw front body,

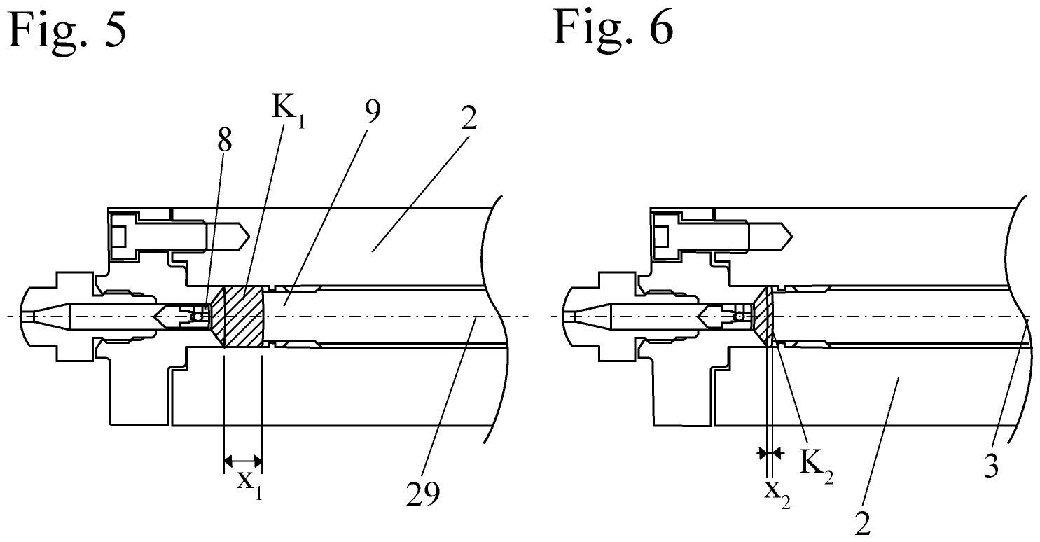

FIGS. 5 & 6, in cross sections, a comparison of the volume in front of the feed front side in the extreme positions,

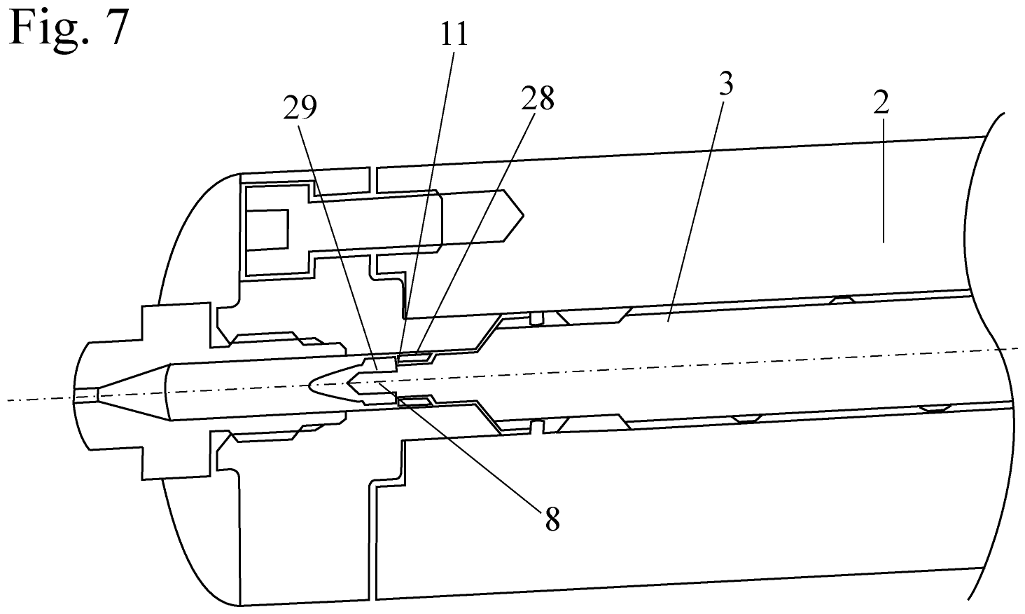

FIG. 7 a cross section through the front region of the injection unit with a ring non-return valve,

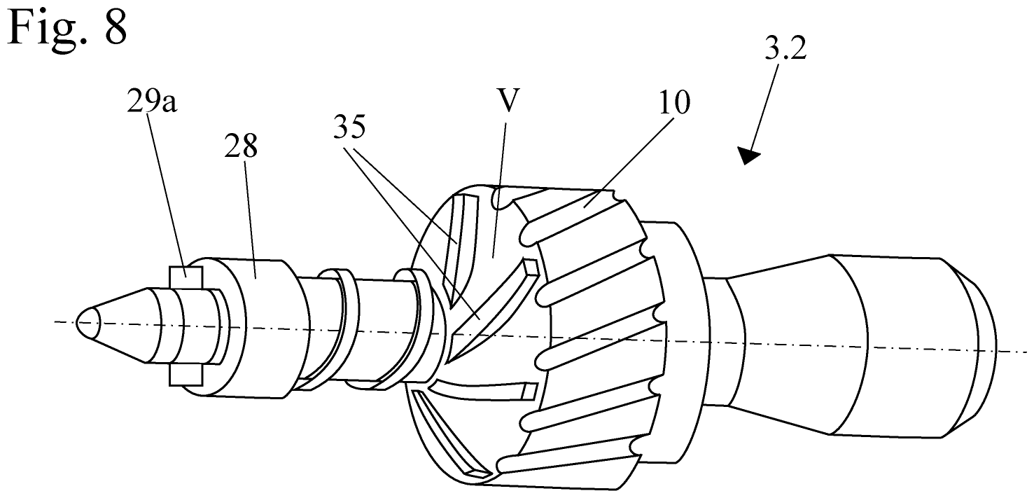

FIG. 8 a perspective representation of an alternative cylinder front body, and

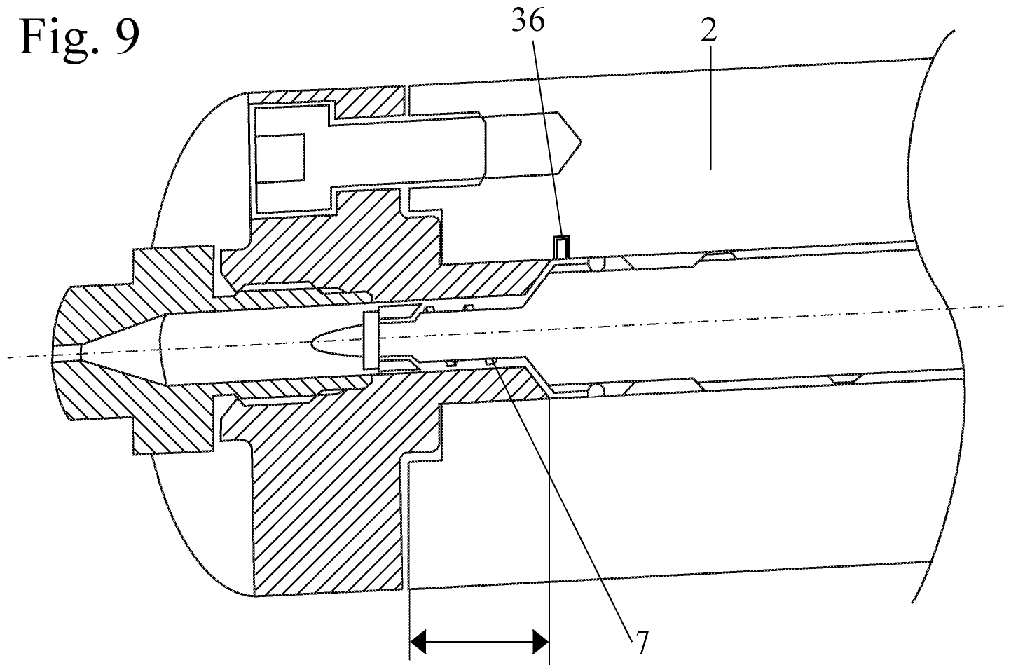

FIG. 9 a cross section as in FIG. 7 with altered details.

A molding machine 100 is schematically represented in FIG. 1. This molding machine 100 has an injection unit 1 and a clamping unit 14, which are arranged on a machine frame 15.

The clamping unit 14 has a stationary platen 16, a movable platen 17 and an end plate 18.

In contrast to the horizontal three-platen machine represented, the clamping unit 14 could also be formed as a two-platen machine or as a vertical machine.

The movable platen 17 is movable relative to the machine frame 15 via a drive device 19. Such a drive device 19 can have a toggle lever mechanism, for example.

The mold halves of a molding tool 13 are clamped or installed on the platens 16 and 17. At least one cavity C is formed in the molding tool 13 represented closed in FIG. 1. An injection channel 20 leads to the cavity C.

The injection unit 1 has an injection cylinder 2 and a plasticizing screw 3 arranged in the injection cylinder 2. This plasticizing screw 3 is rotatable about the longitudinal axis L in the conveying direction F and in the return direction R and movable axially along the longitudinal axis L in the injection direction I.

These movements are initiated via a schematically represented drive device 21. This drive device 21 preferably comprises a rotary drive for the rotational movement and a linear drive for the axial injection movement.

The injection unit 1 (or the drive device 21 thereof) is connected to a control or regulation unit 12 by means of signaling. Control commands are output by the control or regulation unit 12 to the injection unit 1.

The control or regulation unit 12 can be connected to an operating unit or can be an integral component of such an operating unit.

If the injection unit is fitted with a retrofitting set, then the injection unit 1 can be operated in a retrofitting operating mode via the control or regulation unit 12.

The functional sequence of the injection unit 1 (and the entire molding machine 100) is as follows:

Plastic raw material K—preferably in the form of recycled plastic material—is poured into the hopper 22 and enters the interior of the injection cylinder 2. In the infeed and plasticizing zone E of the injection cylinder 2, the plastic raw material is melted and compressed and conveyed further in the injection direction I through a rotational movement of the plasticizing screw 3.

The molten plastic raw material K gradually accumulates in the metering zone M of the injection cylinder 2, wherein this metering zone M also comprises the space in front of the screw.

As soon as enough molten plastic raw material K has accumulated, this is injected into the cavity C via the nozzle head 4, an opening region O in the nozzle head 4 and the injection channel 20 through an axial movement of the plasticizing screw 3 in the injection direction I.

In the cavity C, the plastic hardens to form the molding part. After the molding tool 13 has been opened, the molding part thus formed can be ejected or removed.

In FIG. 1, it can already be seen that the diameter D_{M} of the circular-cylindrical inner wall W_{M} of the metering zone M is smaller than the diameter D_{E} Of the circular-cylindrical inner wall W_{E} Of the infeed and plasticizing zone E.

The transition region U is located between the metering zone M and the infeed and plasticizing zone E and delimits these zones from each other. An annular step of the inner wall of the injection cylinder 2 forms this transition region U.

A cross section through the injection cylinder 2 is schematically represented in FIG. 2. The position represented in the lower image corresponds to the end of the plasticizing and conveying process, whereas the position represented in the upper image corresponds to the end of the injection movement.

The injection cylinder 2 which has the cylinder main body 2.1 and the cylinder front body 2.2—comprising the nozzle head 4—is represented in each case in both images.

The injection cylinder 2 is divided into the infeed and plasticizing zone E and the metering zone M. The transition region U is located in between.

The plasticizing screw 3 has a rear region with a screw flight 6 and a screw channel 7.

In the front region, the plasticizing screw 3 has a substantially cylindrical plunger 8. A non-return valve 11 in the form of a ball or check non-return valve is formed in this plunger 8.

In the lower image, the ball 24 of the ball or check non-return valve is located in the region on the left, with the result that the channel 23 is opened. Through the rotation of the plasticizing screw 3 in the conveying direction F, the plastic raw material K melted in the infeed and plasticizing zone E is conveyed in the injection direction I and via the channel 23 enters the space in front of the screw 25 of the metering zone M through the non-return valve 11. Due to the plastic melt entering the space in front of the screw 25 the plasticizing screw moves axially backwards against the injection direction I.

As soon as enough plastic melt has accumulated in the space in front of the screw 25, the injection process can start. For this, the plasticizing screw 3, as represented in the upper image of FIG. 2, is moved in the injection direction I. As this movement starts the ball 24 of the ball or check non-return valve moves to the right into the closed position, in which the channel 23 is sealed. As a result, no more plastic melt can flow back out of the space in front of the screw 25. At the same time as the plasticizing screw 3 moves in the injection direction I this plasticizing screw 3 is also rotated in the return direction R. The screw tip formed as a cylindrical plunger 8 pushes the plastic melt located in the space in front of the screw 25 via the nozzle head 4 into the cavity C (not represented here).

A cross section through the injection cylinder 2 and the plasticizing screw 3 in the region of the non-return valve 11 and the channel 23 thereof is represented in the section A-A of FIG. 2.

A buffer device 30 is represented both in this cross section and in the variant represented at the top in FIG. 2. This buffer device 30 can be provided optionally. This means that the injection unit 1 also functions without this buffer device 30.

This buffer device 30 has a carrier 31 connected to the injection cylinder 2, a piston 32 movably mounted in the carrier 31 and an energy storage mechanism 33 (e.g. in the form of a spring, a hydraulic pressure accumulator or a pneumatic pressure accumulator) attached on the one hand to the carrier 31 and on the other hand to the piston 32.

The injection unit 1 can be provided with one (or more) melt storage device (schematically represented buffer device 30), which receives the compressed material in the intermediate space during the injection. The displacement work is absorbed by an energy storage mechanism 33, which discharges during the metering and returns the melt to the space in front of the screw again. The piston surface of the piston 32 finishes flush with the injection cylinder 2 (see section A-A), thus completely cleaning the latter. In addition, the piston 32 can be hydraulically or pneumatically controlled or regulated.

The buffer device 30 is shown in another embodiment example in the section A-A, in which the size and the alignment/position of the buffer device 30 are different from the upper cross section of FIG. 2. The dimensions of the injection cylinder 2 also differ from those in the upper cross section of FIG. 2.

A section through the front region of an injection cylinder 2 including plasticizing screw 3 is represented in FIG. 3.

The injection cylinder 2 has the cylinder main body 2.1, in which the infeed and plasticizing zone E is formed. Moreover, the injection cylinder 2 has the cylinder front body 2.2 which is separate from the cylinder main body 2.1, arranged in front of the cylinder main body 2.1 in the injection direction I and detachably connected, preferably screwed via the connection means 26, to the cylinder main body 2.1 and in which the metering zone M is formed.

The cylinder front body 2.2 in turn has a flange element 5, in which most of the metering zone M is formed, and the nozzle head 4 which lies in front of the flange element 5 in the injection direction I and is connected, preferably screwed, to the flange element 5.

It is preferably provided that the cylinder front body 2.2 has an insertion projection 34 protruding in the direction of the cylinder main body 2.1 for inserting the cylinder front body 2.2 into the cylinder main body 2.1. The insertion projection 34 has a, preferably circular-cylindrical, outer surface N with an outer surface diameter D_{N} which corresponds at least in regions to the diameter D_{E} of the circular-cylindrical inner wall W_{E} of the injection cylinder 2.

The cylinder front body 2.2. can also be formed for retrofitting on a cylinder main body 2.1 of an injection cylinder 2. This means that this cylinder front body 2.2 can be retrofitted in the case of an injection cylinder 2 already being used (via the sleeve-shaped insertion projection 34 and the flange element 5 including connection means 26), as a result of which the injection unit 1 is suitable and converted for micro injection molding, for example.

The plasticizing screw 3 has a screw main body 3.1 (with at least one screw flight 6 and at least one screw channel 7; not represented here), wherein the screw main body 3.1 is arranged for the most part in the infeed and plasticizing zone E.

The maximum outside diameter A_{E} of the screw main body 3.1 corresponds to the diameter D_{E}, which remains constant along the longitudinal axis L, of the inner wall W_{E} of the infeed and plasticizing zone E.

The plasticizing screw 3 has a screw front body 3.2 which lies in front of the screw main body 3.1 in the injection direction I and in this case is formed as a separate component, wherein the screw front body 3.2 is arranged at least partially in the metering zone M.

The screw front body 3.2, together with the cylinder front body 2.2, can form a retrofitting set for retrofitting on an injection cylinder 2 and a plasticizing screw 3.

The plasticizing screw 3, in the embodiment example represented in FIG. 3 the screw front body 3.2 thereof, has a screw tip in the form of a substantially cylindrical plunger 8, wherein the cylindrical plunger 8 is arranged in regions in the metering zone M.

The cylindrical plunger 8 has a lateral surface M₈ which corresponds to the inner wall W_{M} of the metering zone M.

The cylindrical plunger 8 has a circular front face S₈ facing towards the nozzle head 4. In the embodiment example represented in FIG. 3, this front face S₈ is formed on a front component 3.3 which is separate from the remaining screw front body 3.2 and is screwed to it. This separate formation ensures that during assembly the ball 24 of the non-return valve 11 can correspondingly be built into the interior of the plunger 8. The flat, circular front face S₈ is aligned at right angles to the longitudinal axis L.

In contrast to the embodiment represented in FIG. 3, the front face S8 is formed conical. Ideally, the front face S₈ corresponds to the nozzle-shaped inner wall W₄ or nestles up against it.

The plasticizing screw 3 (in the embodiment example represented in FIG. 3 the screw front body 3.2 thereof) has a plain bearing 9 arranged behind the cylindrical plunger 8 in the injection direction I, wherein this plain bearing 9 is arranged in the infeed and plasticizing zone E. The plain bearing 9 lies against the inner wall W_{E} with a slight clearance via the contact surface G. The melt channels formed in the plain bearing 9 can also be seen to some extent in FIG. 3.

The plasticizing screw 3 (in the embodiment example represented in FIG. 3 the screw front body 3.2 thereof) has a feed front side V arranged between plain bearing 9 and cylindrical plunger 8 and facing towards the metering zone M.

The injection cylinder 2 has a transition region U—preferably formed on the cylinder front body 2.2—between the circular-cylindrical inner wall W_{E} of the infeed and plasticizing zone E and the circular-cylindrical inner wall W_{M} of the metering zone M. The transition region U in turn has an inner wall W_{U} in the form of a lateral surface of a rotary truncated cone formed around the longitudinal axis L.

In FIG. 3 it can clearly be seen that the feed front side V is formed as a lateral surface of a rotary truncated cone which corresponds to the transition region U.

The non-return valve 11 is formed in the plunger 8 of the plasticizing screw 3. Besides the ball 24, this comprises the channel 23, which is divided into an infeed-side section 23a and an injection-side section 23b. The infeed-side channel 23a in turn has a central channel Z formed along the longitudinal axis L as well as at least one transverse channel Q branching off it. Specifically, in the embodiment example shown, three transverse channels Q branching off the central channel Z are provided which are arranged at regular intervals (i.e. in each case offset by 120°) around the central channel Z.

The nozzle-shaped inner wall W₄ of the nozzle head 4 is formed in the shape of a lateral surface of a rotary truncated cone arranged around the longitudinal axis L.

Moreover, the nozzle head 4 has an opening region O with a circular-cylindrical inner wall W_{O} adjoining the nozzle-shaped inner wall W₄ in the injection direction I.

The portion of the plasticizing screw 3 arranged in the metering zone M has a maximum outside diameter A_{M} which corresponds to the diameter D_{M} of the circular-cylindrical inner wall W_{M} which remains constant along the longitudinal axis L.

FIG. 3 thus clearly shows that the diameter D_{M} of the circular-cylindrical inner wall W_{M} of the metering zone M is smaller than the diameter D_{E} of the circular-cylindrical inner wall W_{E} of the infeed and plasticizing zone E.

If the relative dimensions represented in FIG. 3 are regarded as being true, then the diameter D_{M} of the circular-cylindrical inner wall W_{M} of the metering zone M is less than 50% of the diameter D_{E} Of the circular-cylindrical inner wall W_{E} of the infeed and plasticizing zone E.

In the embodiment example represented in FIG. 3 the plasticizing screw 3 has a nominal diameter (corresponds to the maximum outside diameter A_{E}) of 18 mm. In contrast, the plasticizing screw 3 in the region of the plunger 8 has a diameter A_{M} of 8 mm. In the case of a stroke movement H which is 10 mm as represented, a maximum shot weight of from approximately 0.4 to 0.5 gram results over the surface area of the plunger front side of approximately 0.5 cm².

Only the screw front body 3.2 of the plasticizing screw 3 alone in a three-dimensional drawing is represented in FIG. 4. In the region on the right this screw front body 3.2 has a connection region 27, preferably in the form of a thread.

In the central region of FIG. 4 the plain bearing 9 is represented together with the helically arranged melt channels 10. These melt channels 10 serve to convey the molten plastic raw material K into the metering zone M. This region corresponds to the maximum outside diameter A_{E} Of the plasticizing screw 3. The contact surface G is located between the melt channels 10.

Moreover, the substantially cylindrical plunger 8 of the plasticizing screw 3 is visible in the region on the left in FIG. 4. This plunger 8 has a convex region in the middle portion. Moreover, the outlets of the transverse channels Q and of the injection-side sections 23b of the channel 23 are visible in the region of this plunger 8. This plunger 8 ends with the front component 3.3 on the injection side. The plunger 8 has a maximum outside diameter A_{E} in the region of the metering zone M.

A region of the injection cylinder 2 including plasticizing screw 3 is represented in cross section in FIG. 5, wherein the general components correspond to those of FIG. 3. In FIG. 5, the plasticizing screw 3 is in the position at the end of the plasticizing process before the start of the injection process, such as is also represented in FIG. 2.

There is a particular quantity of molten plastic raw material K between the plain bearing 9 and the feed front side V thereof and the inner wall W_{M} of the injection cylinder 2. Based on the dimensions already specified further above, this plastic raw material K has a volume of approximately 2.5 cm³ (plastic quantity K₁).

If a stroke movement H—from the distance x₁ to the distance x₂ (corresponds to approximately 10 mm)—is carried out in the injection direction I by the plasticizing screw 3 (in order to inject the plastic melt of approximately 0.5 cm³ located in the space in front of the screw 25), then this volume is reduced due to the smaller diameter D_{M} in the metering zone M (e.g. to a plastic quantity K₂ of just 0.5 cm³), such as is represented by way of comparison in FIG. 6.

As this excess volume (difference between the plastic quantities K₁ and K₂ of approximately 2 cm³) can only escape backwards because the non-return valve 11, preferably check valve, is closed during injection, this excess volume must be returned through the melt channels 10 against the injection direction I.

In order to support this return and make it possible, it is provided according to the invention that, during injection, at the same time as the plasticizing screw 3 moves linearly in the injection direction I the plasticizing screw 3 is rotated in a return direction R counter to the conveying direction F. As a result the excess volume is, as it were, sucked back into the region of the screw flight 6 of the plasticizing screw 3.

FIG. 7 shows a cross section through an injection cylinder 2 including plasticizing screw 3, wherein in this embodiment example the non-return valve 11 is formed not as a ball or check non-return valve, but rather as a ring non-return valve with a blocking ring 28 including blocking wings 29. Moreover, in FIG. 7 the plunger 8 is formed with a conical tip.

FIG. 8 shows a perspective representation of a screw front body 3.2. In contrast to FIG. 4, the plunger 8 has a conical screw tip. The non-return valve 11 has a pin 29a and the blocking ring 28.

The non-return valve 11 or the entire cylinder front body 3.2 with reduced diameter can be retrofitted on any conventional plasticizing or injection-molding screw.

Ridges 35 are attached to the feed front side V. These support the pump effect during the backwards rotation and ensure a self-cleaning effect through directed flow conditions.

Further details can be seen in the cross section according to FIG. 9: A pressure sensor 36 is provided in the transition region U.

This pressure sensor 36 can be connected to a control or regulation unit 12, with the result that the current pressure in the transition region can be determined, whereby the current injection pressure can in turn be deduced.

Screw flights 37 are formed in the region of the plunger 8. These screw flights 37 support the conveying of the plastic raw material K.

Moreover, it can be seen in FIG. 9 that the gap in the transition region U is very small when the plasticizing screw 3 is in the foremost position.

Moreover, it can be seen in FIG. 9 that the cylinder front body 2.2—in particular the flange element 5 thereof—has a gradation 38 after the insertion projection 34 in the injection direction I. This gradation serves to center the cylinder front body 2.2 on the injection cylinder 2 during retrofitting. The insertion projection 34 and the gradation 38 together form an insertion region 39.

Finally, it should also be mentioned that large machines can be operated with lower injection forces if a stepped cylinder is used. As a result, the large machine can also be constructed much more simply and conveniently.

### LIST OF REFERENCE NUMBERS

1 injection unit
2 injection cylinder
2.1 cylinder main body
2.2 cylinder front body
3 plasticizing screw
3.1 screw main body
3.2 screw front body
3.3 front component
4 nozzle head
5 flange element
6 screw flight
7 screw channel
8 cylindrical plunger
9 plain bearing
10 melt channels
11 non-return valve
12 control or regulation unit
13 molding tool
14 clamping unit
15 machine frame
16 stationary platen
17 movable platen
18 end plate
19 drive device
20 injection channel
21 drive device
22 hopper
23 channel
23a infeed-side section of the channel 23
23b injection-side section of the channel 23
24 ball
25 space in front of the screw
26 connection means
27 connection region
28 blocking ring
29 blocking wing
29a pin
30 buffer device
31 carrier
32 piston
33 energy storage mechanism
34 insertion projection
35 ridges on feed front side V
36 pressure sensor
37 screw flights in the region of the cylindrical plunger 8
38 gradation
39 insertion region
100 molding machine
K plastic raw material
K₁ (larger) plastic quantity
K₂ (smaller) plastic quantity
L longitudinal axis
E infeed and plasticizing zone
W_{E} inner wall of the infeed and plasticizing zone E
D_{E} diameter of the infeed and plasticizing zone E
I injection direction
M metering zone
W_{M} inner wall of the metering zone M
D_{M} diameter of the metering zone M
W₄ nozzle-shaped inner wall of the nozzle head 4
A_{E} maximum outside diameter of the plasticizing screw in the infeed and plasticizing zone E
A_{M} maximum outside diameter of the plasticizing screw in the metering zone M
M₈ lateral surface of the plunger 8
S₈ front face of the plunger 8
V feed front side
U transition region
W_{U} inner wall of the transition region U
O opening region
W_{O} inner wall of the opening region O
H stroke movement
F conveying direction
R return direction
C cavity
Z central channel
Q transverse channel
N outer surface
D_{N} outer surface diameter
G contact surface
x₁ distance (before stroke movement H)
x₂ distance (after stroke movement H)

1. Injection unit for a molding machine, in particular for an injection-molding machine, with an injection cylinder and a plasticizing screw arranged in the injection cylinder, wherein the plasticizing screw is rotatable about a longitudinal axis for plasticizing plastic raw material and is movable linearly along the longitudinal axis for injecting molten plastic raw material, wherein the injection cylinder has
an infeed and plasticizing zone for the plastic raw material with a circular-cylindrical inner wall with a diameter which remains constant along the longitudinal axis,
a metering zone lying in front of the infeed and plasticizing zone along the longitudinal axis in the injection direction with a circular-cylindrical inner wall with a diameter which remains constant along the longitudinal axis, and
a nozzle head (4) lying in front of the metering zone in the injection direction with a nozzle-shaped inner wall,
wherein the diameter of the circular-cylindrical inner wall of the metering zone is smaller than the diameter of the circular-cylindrical inner wall of the infeed and plasticizing zone.

2. The injection unit according to claim 1, wherein the diameter of the circular-cylindrical inner wall of the metering zone is at most 90%, preferably at most 70%, particularly preferably at most 50%, of the diameter of the circular-cylindrical inner wall of the infeed and plasticizing zone.

3. The injection unit according to claim 1, characterized in that the injection cylinder has a cylinder main body, in which the infeed and plasticizing zone is formed.

4. The injection unit according to claim 3, wherein the injection cylinder has a cylinder front body which is separate from the cylinder main body, arranged in front of the cylinder main body in the injection direction and detachably connected, preferably screwed, to the cylinder main body and in which the metering zone is formed.

5. The injection unit according to claim 4, wherein in the cylinder front body has a flange element, in which most of the metering zone is formed, and the nozzle head which lies in front of the flange element in the injection direction and is connected, preferably screwed, to the flange element.

6. The injection unit according to claim 1, wherein the plasticizing screw has a screw main body with at least one screw flight and at least one screw channel, wherein the screw main body is arranged for the most part in the infeed and plasticizing zone.

7. The injection unit according to claim 6, wherein the maximum outside diameter of the screw main body corresponds to the diameter of the inner wall of the infeed and plasticizing zone.

8. The injection unit according to claim 6, wherein the plasticizing screw has a screw front body which lies in front of the screw main body in the injection direction and is preferably formed separate, wherein the screw front body is arranged at least partially in the metering zone.

9. The injection unit according to claim 1, wherein the plasticizing screw, preferably the screw front body thereof, has a screw tip in the form of a substantially cylindrical plunger, and the cylindrical plunger is arranged in regions in the metering zone.

10. The injection unit according to claim 9, wherein the cylindrical plunger has a lateral surface which corresponds to the inner wall of the metering zone.

11. The injection unit according to claim 9, wherein the cylindrical plunger has a, preferably conical, front face facing towards the nozzle head.

12. The injection unit according to claim 9, wherein the plasticizing screw, preferably the screw front body, has a plain bearing arranged behind the cylindrical plunger in the injection direction, wherein this plain bearing is arranged in the infeed and plasticizing zone.

13. The injection unit according to claim 12, wherein the plain bearing lies against the circular-cylindrical inner wall of the infeed and plasticizing zone with a clearance, preferably with a clearance of from 0.05% to 5% of the nominal diameter of the plasticizing screw.

14. The injection unit according to claim 12, wherein the plasticizing screw, preferably the screw front body thereof, has a feed front side arranged between the plain bearing and the cylindrical plunger and facing towards the metering zone.

15. The injection unit according to claim 12, wherein the plain bearing has several melt channels, preferably formed helical in regions, for allowing molten plastic raw material to pass through from the infeed and plasticizing zone into the metering zone.

16. The injection unit according to claim 1, wherein the injection cylinder has a transition region—preferably formed on the cylinder front body—between the circular-cylindrical inner wall of the infeed and plasticizing zone and the circular-cylindrical inner wall of the metering zone, wherein the transition region has an inner wall in the form of a lateral surface of a rotary truncated cone formed around the longitudinal axis.

17. The injection unit according to claim 14, wherein the feed front side is formed—at least in regions—as a lateral surface of a rotary truncated cone which corresponds to the transition region.

18. The injection unit according to claim 1, wherein the plasticizing screw, preferably the screw front body thereof, has a non-return valve, preferably formed in the cylindrical plunger.

19. The injection unit according to claim 1, wherein the nozzle-shaped inner wall of the nozzle head is formed in the shape of a lateral surface of a rotary truncated cone arranged around the longitudinal axis.

20. The injection unit according to claim 1, wherein the nozzle head has an opening region with a circular-cylindrical inner wall adjoining the nozzle-shaped inner wall in the injection direction.

21. The injection unit according to claim 1, wherein the portion of the plasticizing screw arranged in the infeed and plasticizing zone has a maximum outside diameter of 500 mm, preferably an outside diameter of between 5 mm and 450 mm.

22. The injection unit according to claim 1, wherein the portion of the plasticizing screw arranged in the metering zone has a maximum outside diameter of 400 mm, preferably an outside diameter of between 5 mm and 350 mm.

23. The injection unit according to claim 1, wherein during injection a stroke movement of the plasticizing screw relative to the injection cylinder is effected, wherein the relative stroke movement lies in a range between 0.2 times the nominal diameter of the plasticizing screw and 5 times the nominal diameter of the plasticizing screw, preferably between 0.5 times and 1.2 times the nominal diameter of the plasticizing screw.

24. The injection unit according to claim 1, wherein at least one buffer device for buffering plastic raw material during the injection is attached to the injection cylinder.

25. An injection unit for a molding machine, in particular for an injection-molding machine, with an injection cylinder and a plasticizing screw arranged in the injection cylinder, wherein the plasticizing screw is rotatable about a longitudinal axis in a conveying direction for plasticizing plastic raw material and is movable linearly along the longitudinal axis in the injection direction for injecting molten plastic raw material, wherein, during injection, at the same time as the plasticizing screw moves linearly in the injection direction the plasticizing screw is rotatable in a return direction counter to the conveying direction.

26. The injection unit according to claim 25, wherein a control or regulation unit for controlling or regulating a rotational movement and a linear movement of the plasticizing screw is provided, wherein the control or regulation unit is formed, for injecting the molten plastic raw material into a cavity of a molding tool, to actuate the plasticizing screw at the same time to move linearly in the injection direction and to rotate in the return direction.

27. The injection unit according to claim 25, wherein the movement in the return direction starts at the same time as or before the linear movement in the injection direction.

28. The injection unit according to claim 25, wherein the movement in the return direction ends at the same time as the linear movement in the injection direction.

29. The injection unit according to claim 28, wherein the volume reduction due to the linear movement in the injection direction substantially corresponds to the volume returned due to the movement in the return direction.

30. A molding machine with the injection unit according to claim 1.

31. The molding machine according to claim 30, wherein the molding machine has a clamping unit, wherein a molding tool is installed in the clamping unit and, in the closed state, at least one cavity is formed in the molding tool.

32. A cylinder front body for retrofitting on a cylinder main body of an injection cylinder, wherein the injection cylinder has a circular-cylindrical inner wall with a diameter which remains constant along the longitudinal axis, wherein the cylinder front body
has an insertion projection protruding in the direction of the cylinder main body for inserting the cylinder front body into the cylinder main body, wherein the insertion projection has a, preferably circular-cylindrical, outer surface with an outer surface diameter which corresponds at least in regions to the diameter of the circular-cylindrical inner wall of the injection cylinder, wherein the cylinder front body furthermore has
a circular-cylindrical inner wall with a diameter which remains constant along the longitudinal axis, and
a nozzle head with a nozzle-shaped inner wall lying in front of the insertion projection and the circular-cylindrical inner wall in the injection direction, wherein the diameter of the circular-cylindrical inner wall of the cylinder front body is smaller than the outer surface diameter of the insertion projection.

33. The cylinder front body according to claim 32, wherein the cylinder front body has connection means, preferably in the form of screws, and a flange element, wherein the cylinder front body can be detachably connected, preferably screwed, to the cylinder main body via the flange element and the connection means.

34. A retrofitting set comprising,
the cylinder front body according to claim 32 and
a screw front body for retrofitting on a screw main body which is or can be arranged in the injection cylinder, wherein the screw front body has a screw tip in the form of a substantially cylindrical plunger, a plain bearing arranged behind the cylindrical plunger in the injection direction and a connection region arranged behind the plain bearing in the injection direction for detachably connecting the screw front body to the screw main body.

35. The retrofitting set according to claim 34, wherein the cylindrical plunger has a lateral surface which corresponds to the circular-cylindrical inner wall.

36. The retrofitting set according to claim 34, wherein the plain bearing has a contact surface which corresponds to the circular-cylindrical inner wall of the injection cylinder.
